(19) United States
(12) Patent Application Publication
(10) Pub. No.: US 2019/0093595 A1
(43) Pub. Date: Mar. 28, 2019

(54) AIR INTAKE DUCT AND COMBUSTION SYSTEM OF TURBOCHARGED GASOLINE ENGINE

(71) Applicant: GUANGZHOU AUTOMOBILE GROUP CO., LTD., Guangzhou, Guangdong (CN)

(72) Inventors: Zhuyun Zhang, Guangzhou, Guangdong (CN); Wenfeng Zhan, Guangzhou, Guangdong (CN); Jujiang Liu, Guangzhou, Guangdong (CN); Zhuo Liu, Guangzhou, Guangdong (CN); Shangfen Ding, Guangzhou, Guangdong (CN); Yuhuai Li, Guangzhou, Guangdong (CN)

(21) Appl. No.: 16/094,208

(22) PCT Filed: Apr. 21, 2017
(86) PCT No.: PCT/CN2017/081324

§ 371 Date: Oct. 17, 2018

(30) Foreign Application Priority Data
May 4, 2016 (CN) 201610290262.5

(51) Int. Cl. F02F 1/42; F02B 23/08; F02M 35/10

(52) U.S. Cl. CPC F02F 1/4235; F02B 23/08; F02B 2275/48; F02M 35/10157; F02M 35/10144

(57) ABSTRACT

An air intake duct includes an air intake duct body (11) which includes an air intake part (111) and a connecting part (112) connected with the air intake part (111). A first channel is formed inside the air intake part (111), a second channel intercommunicating with the first channel is formed inside the connecting part (112), one side of the connecting part (112) is provided with a connecting surface (112a) which inclines towards an axis of the air intake duct body (11), the connecting surface (112a) is inclined and extended from a connection joint of the connecting part (112) and the air intake part (111) to an end portion of the connecting part (112), and the first channel has a larger cross section area than the second channel.

### FIELD OF THE INVENTION

The present invention relates to field of turbocharged gasoline engines and, more particularly to an air intake duct and a combustion system of turbocharged gasoline engine.

### BACKGROUND OF THE INVENTION

A combustion system of engine is one of major factors impacting the engine intake quantity and the cylinder combustion. The engine intake quantity of each cylinder of the engine is the premise to ensure the highest power of the engine, and the tumble ratio of the intake air of each cylinder directly affects the combustion performance of the cylinders of the engine and a high tumble ratio. A high tumble ratio and high combustion rate are desired.

Currently, two common manners are utilized to obtain a high tumble ratio.

One manner is to add a tumble valve flange in the air intake duct to adjust the air intake flow. When the tumble valve is turned off, the lower air intake duct is shut and the air completely enters through the upper air intake duct to generate a strong air tumble.

Another manner is to add a protruded shielding device at a position of the combustor far away from the center of the combustor. Specifically, the protruding height of the shielding device is 1-3 mm, which is adapted for blocking the air to go into the combustor through the air intake duct, instead, allowing the air to go into the combustor through the center part of the combustor, thus the air tumble is generated in the combustor to improve combustion efficiency.

However the foregoing manners must use additional parts, which complicates the assembly process and increases manufacturing cost of the combustion system of engine.

### SUMMARY OF THE INVENTION

One objective of the present invention is to provide an air intake duct and a combustion system of turbocharged gasoline engine which can improve combustion efficiency without using additional components.

To achieve the above-mentioned objectives, one aspect of the present invention provides an air intake duct comprising an air intake duct body, the air intake duct body comprising an air intake part and a connecting part connected with the air intake part. A first channel is formed inside the air intake part, a second channel intercommunicating with the first channel is formed inside the connecting part, one side of the connecting part is provided with a connecting surface which inclines towards an axis of the air intake duct body, the connecting surface is inclined and extended from a connection joint of the connecting part and the air intake part to an end portion of the connecting part, and the first channel has a larger cross section area than the second channel.

As a preferable embodiment, the air intake part is provided with an air intake surface which inclines towards the axis of the air intake duct body, and the air intake surface is connected with the connecting surface.

Preferably, the air intake surface is a convex cambered surface that is convex with respect to the axis of the air intake duct body, or is an inclined plane inclining towards the axis of the air intake duct body.

As another preferable embodiment, the connecting surface is a concave cambered surface that is concave with respect to the axis of the air intake duct body, or is another inclined plane inclining towards the axis of the air intake duct body.

Another aspect of the present invention provides a combustion system of turbocharged gasoline engine, which comprises a cylinder cover, a combustor, an air outlet duct and the air intake duct mentioned above. The air intake duct, the combustor and the air outlet duct are formed on the cylinder cover, the air intake duct is connected with an air intake side of the combustor, and the air outlet duct is connected with an air outlet side of the combustor.

As a preferable embodiment, the combustion system further includes an intake valve seat ring arranged on the cylinder cover, wherein one end of the intake valve seat ring is fixed to the connecting part of the air intake duct, and another end of the intake valve seat ring is connected with the air intake side of the combustor.

As another preferable embodiment, the combustion system further includes a sparking plug electrode arranged in the combustor and at least one squeezing structure arranged at the air intake side of the combustor.

Preferably, the squeezing structure is a concave surface formed on the combustor, and the squeezing structure is recessed towards the sparking plug electrode or is a tangential plane formed on the combustor.

More preferably, the squeezing structure and the combustor are formed in one piece.

As one more preferable embodiment, the combustion system further includes an outlet valve seat ring, wherein one side of the outlet valve seat ring is fixed to an air outlet of the air outlet duct, and another side of the outlet valve seat ring is connected with the air outlet side of the combustor.

In comparison with the prior art, the air intake part of the air intake duct according to the present invention has the first channel and the second channel that are intercommunicated with each other, and the connecting part is provided with the connecting surface inclined towards the axis of the air intake duct body, so that the cross section area of the air intake part is larger than that of the connecting part. When the air flows into the air intake duct, the airflow direction will be forcibly changed due to the squeezing action of the connecting surface, causing the airflow with high tumble ratio to be generated at the connecting surface, thereby improving the combustion efficiency of the engine. In this manner, it's unnecessary to arrange additional component in the air intake duct or on the cylinder cover, therefore the structure of the combustion system is simple, and the manufacturing method is reduced.

### BRIEF DESCRIPTION OF THE DRAWINGS

The accompanying drawings facilitate an understanding of the various embodiments of this invention. In such drawings:

FIG. 1 is a schematic diagram of an air intake duct according to one embodiment of the present invention;

FIG. 2 is a schematic diagram of a combustion system of turbocharged gasoline engine according to one embodiment of the present invention; and

FIG. 3 is another schematic diagram of FIG. 2.

### NUMERALS

combustion system of turbocharged gasoline engine 100; air intake duct 10; air intake duct body 11; air intake part 111; air intake surface 111a; connecting part 112; connecting surface 112a; axis L; cylinder cover 20; intake valve seat ring 30; combustor 40; squeezing structure 41; sparking plug electrode 50; air outlet duct 60; outlet valve seat ring 70.

### DETAILED DESCRIPTION OF ILLUSTRATED EMBODIMENTS

A distinct and full description of the technical solution of the present invention will follow by combining with the accompanying drawings. By all appearances, the embodiments to be described just are a part of embodiments of the present invention, not the all. Based on the embodiment of the present invention, all other embodiments obtained by the person ordinarily skilled in the art without any creative work pertain to the protection scope of the present invention.

For description, terms used thereinafter such as “below”, “beneath”, “above”, “on” are for illustrating relationship or connection of the elements or features. It can be understood that, if one element or one layer is connected or coupled to another element or another layer, it can be explained as follow: the element or layer is directly or indirectly formed on the other element or layer, or indirectly directly connected or indirectly coupled to the other element or layer.

In the descriptions thereinafter, specific embodiments are, accordingly, to be regarded as “illustrative and exemplary rather than restrictive”. The terms “comprising”, “including” and “having”, as used herein are intended to be read as open-ended terms, in other words, other features, steps, elements, parts, or/and combinations thereof can be included. In the following descriptions, the invention is described with reference to specific exemplary embodiments thereof, but those skilled in the art will recognize that the invention is not limited thereto. The scope of the invention is defined by the appended claims.

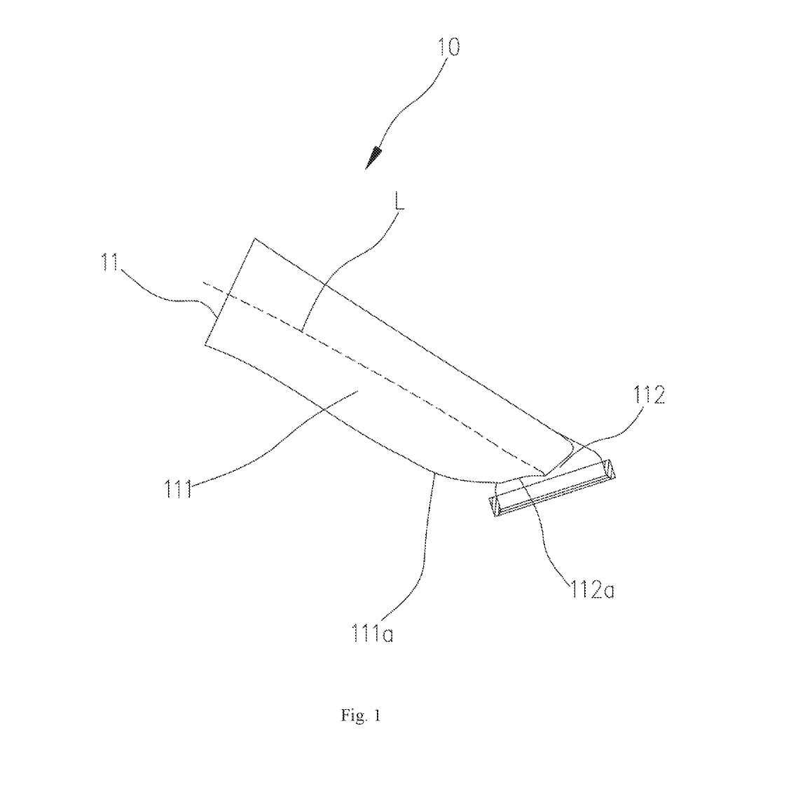

Referring to FIG. 1, an air intake duct 10 of the present invention includes an air intake duct body 11 which has an air intake part 111 and a connecting part 112 connected with the air intake part 111. A first channel (not shown) is formed inside the air intake part 111, a second channel (not shown) intercommunicating with the first channel is formed inside the connecting part 112, one side of the connecting part 112 is provided with a connecting surface 112a which inclines towards an axis of the air intake duct body 11, the connecting surface 11a is inclined and extended from a connection joint of the connecting part 112 and the air intake part 111 to an end portion of the connecting part 111, so that the cross section area of the first channel is larger than that of the second channel. In this embodiment, the air intake duct 10 is applicable to a combustion system of turbocharged gasoline engine.

In this embodiment, since the connecting surface 112a is configured on the connecting part 112 which is intercommunicated with air intake part 111, further the connecting surface 112a is inclined towards the axis L of the air intake duct body 11, thus the cross section area of the first channel is larger than that of the second channel. As a result, when air enters into the air intake body 11, the air will be gathered at the connecting surface 112a of the connecting part 112 by means of the squeezing action of the connecting surface 112, therefore tumble ratio of the air is increased thereby improving the combustion efficiency of the engine.

In a preferable embodiment, for further increasing the tumble ratio of the air, the air intake part 111 is provided with an air intake surface 111a which inclines towards the axis L of the air intake duct body 11, and the air intake surface 111a is connected with the connecting surface 112a. In other words, the cross section area of the first channel at the position of the air intake surface 111a is larger than the cross section area of the second channel at the position of the connecting surface 112a. Specifically, the air intake surface 111a is a convex cambered surface that is convex with respect to the axis L of the air intake duct body 11, or is an inclined plane inclining towards the axis L of the air intake duct body 11, so that the intake duct body 11 has a bigger diameter at a position near to the connecting part 112, thereby more airflow will be gathered there. More specifically, the air intake surface 111a and the air intake duct body 11 can be formed by one-piece molding.

Preferably, the connecting surface 112a is a concave cambered surface that is concave with respect to the axis L of the air intake duct body 11, or is an inclined plane inclining towards the axis L of the air intake duct body 11. Thus the diameter of the connecting part 112 is smaller than that of the air intake part 111, therefore a great amount of air will be gathered at the connecting surface 1112 of the connecting part 112 when air flows to the air intake surface 111a and the connecting surface 112a, thereby airflow with high tumble ratio is generated to increase combustion efficiency in the combustor since turbulence energy of air is generated in the cylinder.

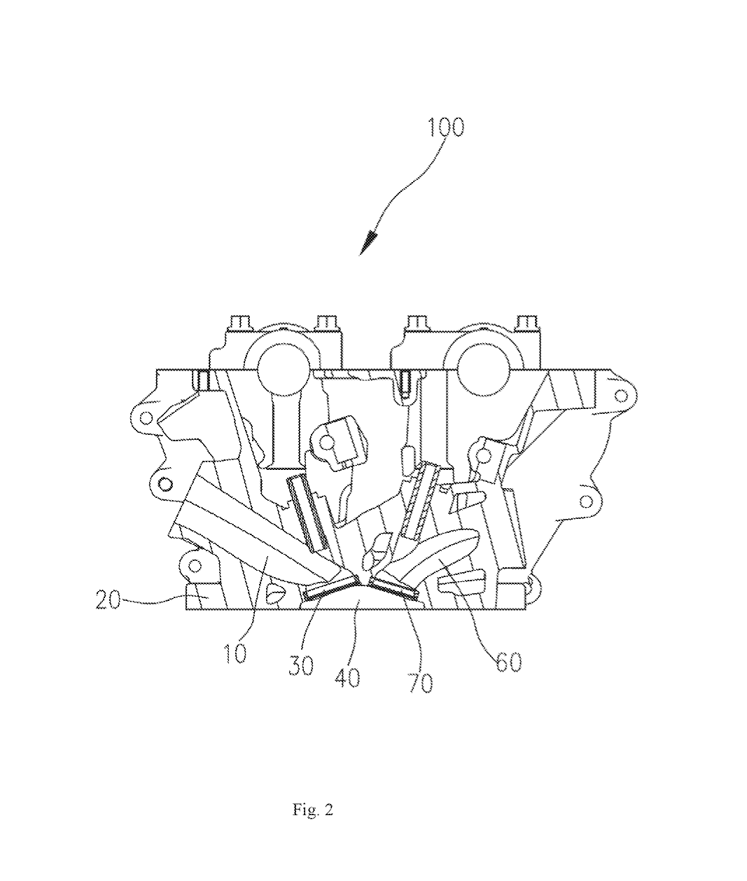

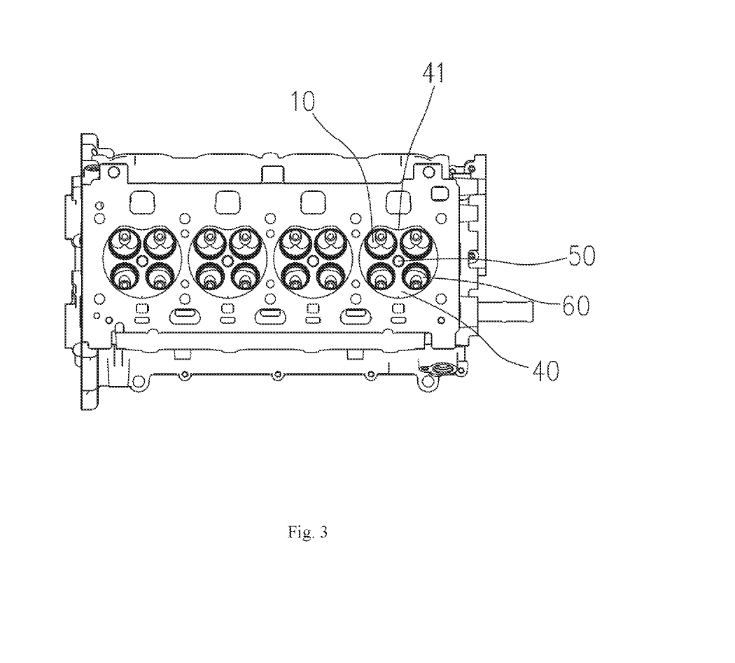

Referring to FIGS. 2 to 3, a combustion system of turbocharged gasoline engine 100 of the present embodiment includes a cylinder cover 20, a combustor 40, an air outlet duct 60 and the air intake duct 10 mentioned above. The air intake duct 10, the combustor 40 and the air outlet duct 60 are arranged on the cylinder cover 20, the air intake duct 10 is connected with an air intake side of the combustor 40, and the air outlet duct 60 is connected with an air outlet side of the combustor 40. In this embodiment, the air intake duct 10 is embedded on the cylinder cover 20, and the amount of the air intake duct 10 can be one or more.

In the present embodiment, the combustion system of turbocharged gasoline engine 100 further includes an intake valve seat ring 30 arranged on the cylinder cover 20, one side of the intake valve seat ring 30 is fixed to the connecting part 112 of the air intake duct, and another side of the intake valve seat ring 30 is connected with the air intake side of the combustor 40, so that the airflow gathered at the connecting part 112 will be guided by the intake valve seat ring 30 to reach the combustor 40. Specifically, the intake valve seat ring 30 is arranged on the cylinder cover 20 in a press-fitting manner.

Further, the combustion system of turbocharged gasoline engine 100 further includes a sparking plug electrode 50 arranged in the center of the combustor 40 and at least one squeezing structure 41 arranged at the air intake side of the combustor 40. Specifically, the combustor 40 is embedded on the cylinder cover 20, and the squeezing structure 41 is arranged for squeezing the air at the air intake side of the combustor 40, so that a great of airflow is squeezed to reach the sparking plug electrode 50 thereby improving the combustion efficiency so as to finally improve the combustion performance of the engine. More specifically, the squeezing structure 41 is a concave surface formed on the combustor 40 and is dented towards the sparking plug electrode 50, so that a great of airflow can be squeezed to reach the sparking plug electrode 50 to form high tumble ratio air, thereby generating turbulence energy around the sparking plug electrode 50 to finally improve combustion efficiency. Preferably, the squeezing structure 41 and the combustor 40 are formed in one piece, so as to simplify manufacturing procedure. To be understood easily, the amount of the squeezing structure 41 can be one or two, or even more, which is dependent on the airflow direction deviating from the position of the sparking plug electrode 50.

Furthermore, in other embodiments, the squeezing structure 41 can be a tangential plane formed on the combustor 40, which also can squeeze the airflow deviating from the position of the sparking plug electrode 50 back to the center position.

In the present embodiment, the combustion system 100 further includes an outlet valve seat ring 70, one end of the outlet valve seat ring 70 is fixed to an air outlet of the air outlet duct 60, and another end of the outlet valve seat ring 70 is connected with the air outlet side of the combustor 40. Specifically, the air outlet duct 60 is embedded on the cylinder cover 20, and the outlet valve seat ring 70 is connected with the air outlet side of the combustor 40 so that the gas after combusting is discharged through the air outlet duct 60. To be understood easily, the amount of the air outlet duct 60 can be one, two or more. Specifically, the air outlet duct 60 is configured opposite to the air intake duct 10, and the number of the outlet valve seat ring 70 is corresponding with that of the air outlet duct 60.

The working principle of the combustion system of turbocharged gasoline engine 100 follows.

Firstly, fresh air is entered to the air intake duct 10 to mix with the fuel spray injected by the fuel injector to form fuel-air mixture. At this time, the air intake valve is opened and the piston moves downwards, so that the fuel-air mixture flows through the air intake surface 111a of the air intake part 111 and the connecting surface 112a of the connecting part 112, and then generates airflow with high tumble ratio which is beneficial to combust at the position of the connecting part 112, finally the air flow with high tumble ratio is guided by the air intake valve seat ring 30 to reach the combustor 40. In such a way, high turbulence energy is generated in the combustor 40 due to the airflow with high tumble ratio, at this time, the prison moves upwards to press the airflow with high tumble ratio to reach the squeezing structure 41 of the combustor 40. By means of the squeezing action, the airflow with turbulence energy is gathered around the sparking plug electrode 50 and will be lighted to push the prison to move upwards again; finally the combustion waste gas will be discharged from the air outlet duct 60. In such a way, one combustion process of engine is completed.

In the present invention, the connecting surface 112a inclined towards the axis L of the air intake duct body 11 is provided at the connecting part 112 which is intercommunicated with the air intake part 111, therefore the cross section area of the air intake part 111 is larger than that of the connecting part 112. When the air flows into the air intake duct 10, the air flow direction will be forcibly changed due to the squeezing action of the connecting surface 112a, causing the airflow with high tumble ratio to be generated at the connecting surface 112a, thereby improving the combustion efficiency of the engine. In this manner, it's unnecessary to arrange additional component in the air intake duct or on the cylinder cover, therefore the structure of the combustion system is simple, and the manufacturing method is reduced.

In the foregoing descriptions, the specification and drawings are, accordingly, to be regarded as “illustrative and exemplary rather than restrictive”. The terms “comprising”, “including” and “having”, as used herein are intended to be read as open-ended terms. Terms such as “one embodiment”, “embodiments”, “a first embodiment”, or “examples” are used in different descriptions, and the specific features, structures, or materials mentioned in a certain embodiment or example can be combined in any one or more embodiments or examples.

While the invention has been described in connection with what are presently considered to be the most practical and preferable embodiments, it is to be understood that the invention is not to be limited to the disclosed embodiments, but on the contrary, is intended to cover various modifications and equivalent arrangements included within the spirit and scope of the invention.

What is claimed is:

1. An air intake duct, comprising an air intake duct body, the air intake duct body comprising an air intake part and a connecting part connected with the air intake part;
wherein a first channel is formed inside the air intake part, a second channel intercommunicating with the first channel is formed inside the connecting part, one side of the connecting part is provided with a connecting surface which inclines towards an axis of the air intake duct body, the connecting surface is inclined and extended from a connection joint of the connecting part and the air intake part to an end portion of the connecting part, and the first channel has a larger cross section area than the second channel.

2. The air intake duct according to claim 1, wherein the air intake part is provided with an air intake surface which inclines towards the axis of the air intake duct body, and the air intake surface is connected with the connecting surface.

3. The air intake duct according to claim 2, wherein the air intake surface is a convex cambered surface that is convex with respect to the axis of the air intake duct body, or is an inclined plane inclining towards the axis of the air intake duct body.

4. The air intake duct according to any one of claims 1 to 3, wherein the connecting surface is a concave cambered surface that is concave with respect to the axis of the air intake duct body, or is another inclined plane inclining towards the axis of the air intake duct body.

5. A combustion system of turbocharged gasoline engine, comprising a cylinder cover, a combustor, an air outlet duct and the air intake duct according to any one of claims 1 to 4, wherein the air intake duct, the combustor and the air outlet duct are formed on the cylinder cover, the air intake duct is connected with an air intake side of the combustor, and the air outlet duct is connected with an air outlet side of the combustor.

6. The combustion system of turbocharged gasoline engine according to claim 5, further comprising an intake valve seat ring arranged on the cylinder cover, wherein one end of the intake valve seat ring is fixed to the connecting part of the air intake duct, and another end of the intake valve seat ring is connected with the air intake side of the combustor.

7. The combustion system of turbocharged gasoline engine according to claim 5, further comprising a sparking plug electrode arranged in the combustor and at least one squeezing structure arranged at the air intake side of the combustor.

8. The combustion system of turbocharged gasoline engine according to claim 7, wherein the squeezing structure is a concave surface formed on the combustor, and the squeezing structure is recessed towards the sparking plug electrode or is a tangential plane formed on the combustor.

9. The combustion system of turbocharged gasoline engine according to claim 7 or claim 8, wherein the squeezing structure and the combustor are formed in one piece.

10. The combustion system of turbocharged gasoline engine according to claim 5, further comprising an outlet valve seat ring, wherein one side of the outlet valve seat ring is fixed to an air outlet of the air outlet duct, and another side of the outlet valve seat ring is connected with the air outlet side of the combustor.
